(19) United States
(12) Patent Application Publication
(10) Pub. No.: US 2018/0218259 A1
(43) Pub. Date: Aug. 2, 2018

(54) OPTIMIZING NODE LOCATIONS WITHIN A SPACE

(71) Applicant: International Business Machines Corporation, Amonk, NY (US)

(72) Inventors: Alan Braz, Campinas (BR); Fabrizio N. Caldas, Hortolandia (BR); Heloisa Caroline de Souza Pereira Candello, Campinas (BR); Paulo Henrique de Almeida Cavoto, Campinas (BR); Argemiro Jose de Lima, Campinas (BR)

(21) Appl. No.: 15/419,107

(22) Filed: Jan. 30, 2017

(51) Int. Cl. G06N 3/08; G06F 17/11

(52) U.S. Cl. CPC G06N 3/08; G06F 17/11

(57) ABSTRACT

A system, method and program product for arranging a set of nodes having disparate cognitive learning capabilities in a space. A method is provided that includes: receiving node related inputs that include structured data and unstructured data; identifying existing relationships and interactions among the nodes by analyzing external resource data; generating a cognitive profile for each node in the set of nodes based on the node related inputs; determining a compatibility for each pair of nodes in the set of nodes based on generated cognitive profiles and existing relationships and interactions; and calculating an arrangement based on the compatibility determined for each pair of nodes.

### TECHNICAL FIELD

The subject matter of this invention relates to optimizing the location of nodes within a space, and more particularly to a tool for arranging nodes within a space based on external inputs to enhance cognitive learning results.

### BACKGROUND

In complex learning based systems, entities (i.e., nodes) within the system enhance their cognitive capabilities via various stimuli including, e.g., analyzing and processing data, training, experiences, etc. In certain platforms, nodes having different cognitive capabilities must be thoughtfully arranged within a space to achieve an overall optimal cognitive learning result for each of the individual nodes, as well as the system as a whole. In such a system, each node may for example employ a learning capability whose efficacy is impacted both by its location within the space and the node's capacity to interact in a meaningful manner with other nodes in the system. Accordingly, optimally arranging nodes to most effectively interact with other “compatible” nodes may significantly improve the cognitive learning results.

Determining compatibilities between nodes may for example be based on various factors including: existing capabilities, known limitations, prior interactions, environmental settings, etc. For example, two nodes that have a history of productive interactions should ideally be paired to exploit this compatibility. Similarly, two nodes that have a history of incompatibility should not be paired. Further, locating lower performing nodes near higher performing nodes may be advantageous to enhance the learning of the lower performing nodes.

Because of the complex nature of learning, arranging nodes within a space to optimize the best result for the all the nodes can present a challenge particularly in the case where each node has unique learning capabilities. Furthermore, because of the dynamic nature of learning, different nodes may progress at different rates, which may result in an ongoing need to modify the arrangement. Often, the arrangement task is handled by an administrative entity that lacks any tangible criteria for decision making.

### SUMMARY

Aspects of the present disclosure provide a technology platform for arranging nodes in a space, in which the nodes have disparate learning capabilities.

A first aspect discloses a system for arranging a set of nodes having disparate cognitive learning capabilities in a space, including: an interface for receiving node related inputs that include structured data and unstructured data; a retrieval system that identifies existing relationships and interactions among the nodes by analyzing external resource data; a cognitive profile generator that generates a cognitive profile for each node in the set of nodes based on the node related inputs; a compatibility determiner that determines a compatibility for each pair of nodes in the set of nodes based on generated cognitive profiles and existing relationships and interactions; and an arrangement calculator that calculates an arrangement based on the compatibility determined for each pair of nodes.

A second aspect discloses a computer program product stored on a computer readable storage medium, which when executed by a computing system, arranges a set of nodes having disparate cognitive learning capabilities in a space, including: program code for receiving node related inputs that include structured data and unstructured data; program code that identifies existing relationships and interactions among the nodes by analyzing external resource data; program code that generates a cognitive profile for each node in the set of nodes based on the node related inputs; program code that determines a compatibility for each pair of nodes in the set of nodes based on generated cognitive profiles and existing relationships and interactions; and program code that calculates an arrangement based on the compatibility determined for each pair of nodes.

A third aspect discloses a computerized method for arranging a set of nodes having disparate cognitive learning capabilities in a space, including: receiving node related inputs that include structured data and unstructured data; identifying existing relationships and interactions among the nodes by analyzing external resource data; generating a cognitive profile for each node in the set of nodes based on the node related inputs; determining a compatibility for each pair of nodes in the set of nodes based on generated cognitive profiles and existing relationships and interactions; and calculating an arrangement based on the compatibility determined for each pair of nodes.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having an arrangement system according to embodiments.

FIG. 2 shows a flow diagram for arranging students in a classroom according to embodiments.

FIG. 3 shows student interfaces according to embodiments.

FIG. 4 shows teacher interfaces according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Present embodiments provide a technology platform for arranging nodes in a learning based environment to enhance cognitive learning results. The learning based environment may comprise any setting, platform, device or model in which a collection of nodes is provided that have disparate cognitive capabilities. For example, the learning based environment may include: a machine learning environment in which a set of neural networks require training; an artificial intelligence platform; a network of robots; a system of autonomous vehicles; a real world classroom; a workplace environment; etc. Nodes may for example include computers, mobile devices, vehicles, humans, virtual resources, network resources, devices in an Internet of Things (IoT) environment, smart devices, smart clothing, robots, etc.

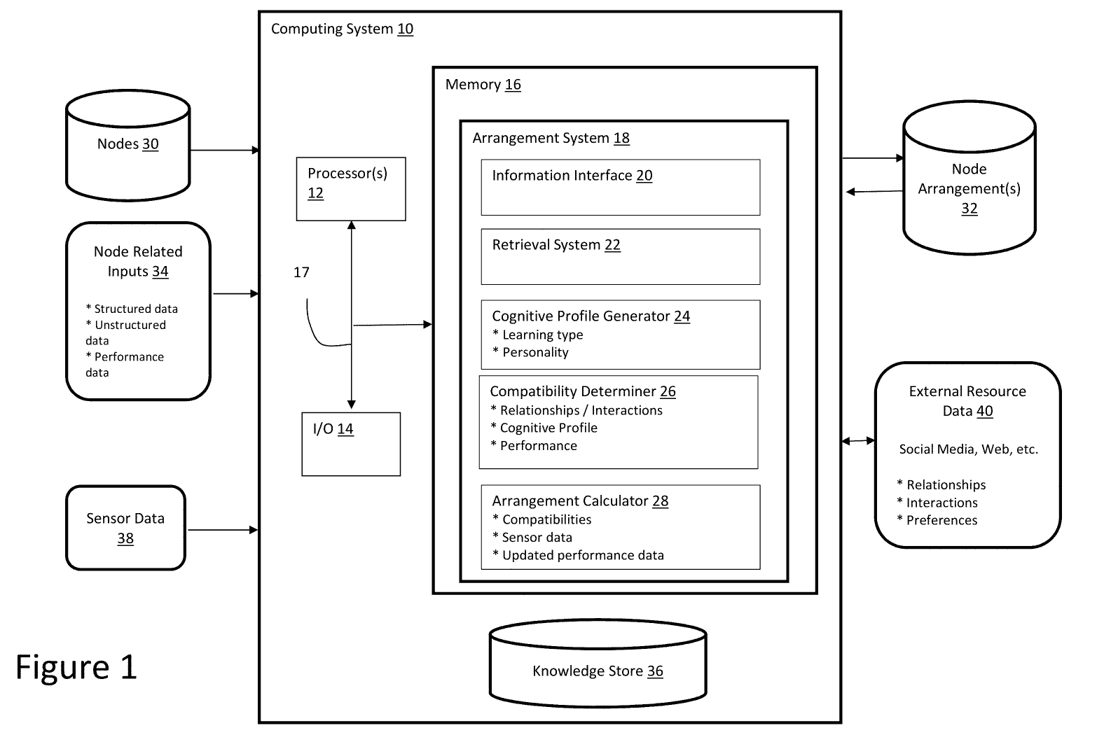

Referring now to the drawings, FIG. 1 depicts a computing system 10 that includes an arrangement system 18 that generates one or more node arrangements 32 for an inputted set of nodes 30. A node arrangement 32 may for example comprise a physical arrangement, a virtual arrangement, a network arrangement, etc. Arrangement system 18 generally includes: an information interface 20 (e.g., a user interface, API, etc.) that receives node related inputs 34 (which generally includes structured and unstructured data collected from the nodes 30 or from an associated administrator); a retrieval system 22 that retrieves and analyzes external resource data 40 (e.g., social network data, Web data, network data, proprietary database data, etc.) to identify, e.g., relationships, prior interactions, preferences, etc., among the nodes 30; a cognitive profile generator 24 that generates a cognitive profile for each node 30 based, e.g., on the node related inputs 34 and/or external resource data 40; a compatibility determiner 26 that determines a compatibility of each pair of nodes from the inputted set of nodes 30 based, e.g., on the identified relationships and interactions, the generated cognitive profiles, performance data, inputted sensor data 38, etc.; and an arrangement calculator 28 that calculates one or more node arrangements 32, e.g., based on determined compatibilities, sensor data 38, updated performance data, etc.

In one illustrative embodiment, arrangement system 18 may be utilized to provide an optimal seating arrangement for students in a classroom, in which each of the inputted nodes comprises an identifier or device associated with student, e.g., a student ID, a smart device, an assigned workstation, etc. In this example, arrangement system 18 determines the optimal location for a student in a classroom and the optimal arrangement of all the students inside a classroom based on inputted parameters. Arrangement system 18 continuously or periodically collects, determines and stores parameter data and resulting arrangement data in a knowledge store 36. A calculated arrangement is then dynamically updated from time-to-time as new inputted information is collected. Arrangement system 18 may employ cognitive capabilities to continuously learn and surmise which arrangements result in the best performance.

In this embodiment, the location of a student is calculated using parameters such as students' grades and capabilities (i.e., performance information ascertained from structured and unstructured inputs), social relationships (e.g., based on social media), general behavior (e.g., manually provided by the teacher), student preferences, personality type, learning type, etc. The arrangement calculator 28 may include a cognitive system capable of learning data and patterns from these parameters to propose seating arrangements and classroom layouts. Thus, node arrangements 32 can be adjusted to adapt dynamically as the arrangement system 18 augments its knowledge store 36 with incoming data.

In a further embodiment, arrangement system 18 may be utilized to arrange autonomous vehicles having disparate cognitive capabilities in a space, such as a highway, in order to maximize overall learning and performance of all the vehicles. In another embodiment, arrangement system 18 may be utilized to arrange heterogeneous robots employing artificial intelligence in a workplace to maximize overall machine learning of the robots. Accordingly, arrangement system 18 comprises a technology platform capable of solving the technological problem of arranging cognitive nodes in a space, in a domain-independent manner.

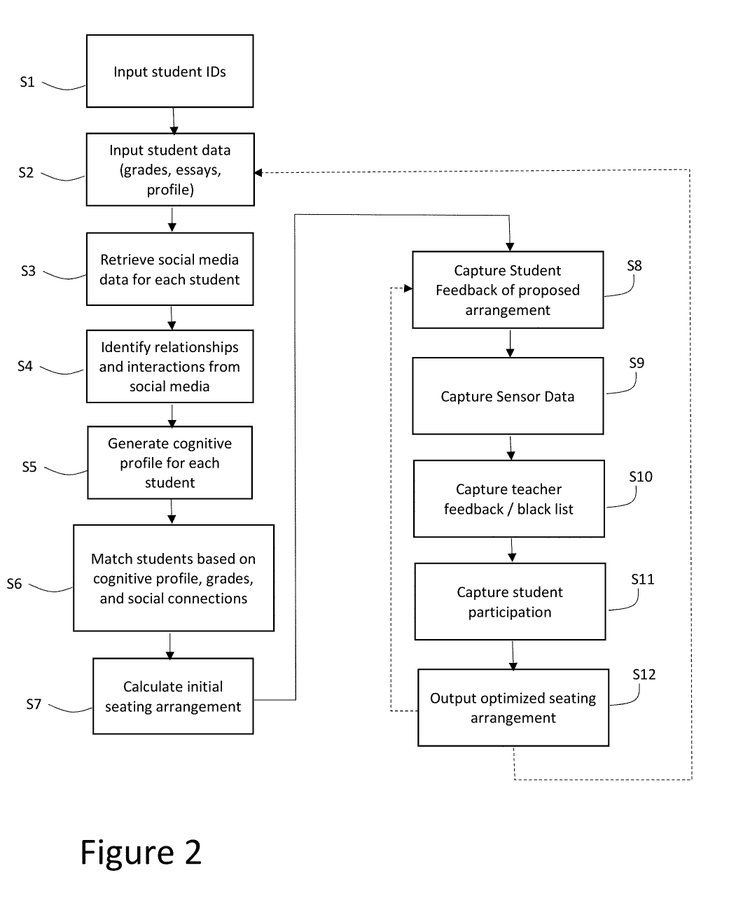

FIG. 2 depicts a flow diagram of a method of implementing a seating arrangement using arrangement system 18 of FIG. 1. At S1, a set of student ID's (i.e., nodes 30) are inputted, e.g., by a teacher looking to optimally arrange students in a classroom. At S2, student data (i.e., node related inputs 34) is inputted, which may for example include: (1) structured data such a spreadsheet of grades, user created profile data, etc.; and (2) unstructured data, e.g., essays written by the student, hand written nodes associated with a problem solving task, an oral presentation, etc. Student data is for example stored in a set of parameters in the knowledge store 36.

At S3, social media data is retrieved from social networks by retrieval system 22, and at S4, relationships and interactions are identified for each student from the social media data. Relationships may for example include friends, followers, etc. Interactions may for example include posts made by the user, posts read by the user, etc. Relationship and interaction data may also be stored as unique parameters for each student. At S5, a cognitive profile is generated for each student, which may for example include a personality type, a learning style, cognitive capabilities, grades, etc. The cognitive profile may be generated by a deep learning system such as WATSON®, which utilizes advanced natural language processing, information retrieval, knowledge representation, automated reasoning, and machine learning to arrive at a supposition based on a collections of structured and unstructured data. Thus for example, by analyzing essays, oral presentations, grades, social media interactions, etc., cognitive profile generator 24 can create a cognitive profile of each student. The cognitive profile may likewise be stored as one or more parameters for each student. The parameters may be stored in the knowledge store 36 (FIG. 1) in any form, as vector data, XML data, a data structure, etc.

At S6 students are evaluated for compatibility (i.e., matched) based on identified relationships and interactions, cognitive profile similarities, grades. Matches between students can be determined in any manner. For example, students may be evaluated based on the collected and/or determined parameters, in which each parameter has a different weight range based on a perceived importance. The following is an illustrative set of individual parameters and associated ranges and weights:

| Parameter | Description | Range | Weight |
|---|---|---|---|
| Level of | Determined by a sensor that picks up the noise level | 0-10 | 10 |
| participation | and gaze of each student. This sensor gives a value | | |
| (LP) | from 0 to 10, 10 being high participation. | | |
| Teacher input | Behavior evaluation manually input by the teacher | 0-10 | 10 |
| (TI) | from 0 to 10 where 0 is very bad and 10 very good. | | |
| Grades (GR) | Average of all individual grades (manual input) for | 0-10 | 9 |
| | that specific course. | | |
| Personality | The parameter introvert/extrovert is considered. | 0-10 | 8 |
| Insight (PI) | | | |
| Previous seat | The student input has a range from 0 to 10, 10 being | 0-10 | N/A |
| evaluation/ | I liked very much where I was seated. | | |
| feedback (PS) | | | |

The following is an illustrative set of pairwise parameters and associated ranges and weights:

| Parameter | Description | Range | Weight |
|---|---|---|---|
| Black list (BL) | Manual input of the teacher if those | 0-1 | N/A |
| | 2 students should seat closely (1) | | |
| | or not (0). | | |
| Friendship | Use social media API to detect | 0-10 | 5 |
| degree (FD) | friendship link. If the two students | | |
| | are not friends the value is 0. The | | |
| | value will increase depending on | | |
| | the amount of interaction exchange | | |
| | between them. | | |

Then for each pair of Students S1 and S2, matching is calculated as:

M(S1,S2)=BL(1,2)*[(LP1+LP2)*10+(TI1+TI2)*10+(|GR1−GR2|)*9+(|PI1−PI2|)*8+FD(1,2)*5].

The formula for calculating the value for each pair is the sum of the level of participation for each pair multiplied by the weight, plus the sum of the teacher input for each pair multiplied by the TI weight, plus the absolute value of the subtraction of the grade for each pair multiplied by the GR weight, plus the absolute value of the subtraction for the personality insight multiplied by the PI weight, plus the friendship degree multiplied by the FD weight.

The reason for subtracting grade and personality insight values are so that the pair is best suited when values are inversely proportional. The personality insight was considered only for the introversion and extroversion.

To calculate the new suggested seating arrangement, the system receives as input:

1. All pair scores: M(X,Y)

2. Individual: Previous seat evaluation/feedback (PS)

3. Teacher: Overall Previous Arrangement evaluation.

The following is an example of the pair-wise matching:

### Individual Values:

| Parameter | John (S1) | Maria (S2) | Ana (S3) |
|---|---|---|---|
| Level of participation (LP) | 10 | 2 | 7 |
| Teacher input (TI) | 1 | 6 | 10 |
| Grades (GR) | 8 | 5 | 9 |
| Personality Insight (PI) | 3 | 10 | 6 |

### Pair-Wise Values:

| Black List (0-1): | Friendship degree (FD): |
|---|---|
| John (S1) and Maria (S2) = 1 | John (S1) and Maria (S2) = 0 |
| John (S1) and Ana (S3) = 1 | John (S1) and Ana (S3) = 3 |
| Maria (S2) and Ana (S3) = 0 | Maria (S2) and Ana (S3) = 7 |

### Matching:

M(S1,S2)=1*[(10+2)*10+(1+6)*10+(|8−5|)*9+(|3−10|)*8+0*5]=273

M(S1,S3)=1*[(10+7)*10+(1+10)*10+(|8−9|)*9+(|3−6|)*8+3*5]=328

M(S2,S3)=0*[(2+7)*10+(6+10)*10+(|5−9|)*9+(|10−6|)*8+7*5]=0

According to this scenario the likelihood of Ana and John having a better performance seating closer is greater than if Maria was paired with John. Also, Maria and Ana should sit as far as possible due to the Black List.

At S7, an initial seating arrangement is calculated. For example, given a compatibility score for each pair of students, an iterative process may be employed to find an optimal seating arrangement. For example, knowing that student A should be located next to student B, student B with student Q, student Q with student X, student Y with student Z, etc., an initial arrangement can be generated as follows, e.g.,

Row 1: A-B-Q

Row 2: Y-Z-X.

After the initial seating arrangement is generated, a repeatable inner loop (S8-S12) can be implemented in which student feedback is captured at S8 (does the student like his or her seat location?) and sensor data is captured at S9 (e.g., temperature, lighting, etc., sensed at different classroom locations). Similarly, at S10, teacher feedback can collected, e.g., observations about how student appear to be performing, black list data (i.e., students that should not be paired), etc., and at S11 student participation information can be collected. Finally, at S12 an optimized seating arrangement is outputted using the information collected in the inner loop.

After an optimized seating arrangement is generated at S12, the process can also loop back to S2 at which time the entire process can be repeated (e.g., when new grades are posted, every few weeks, etc.).

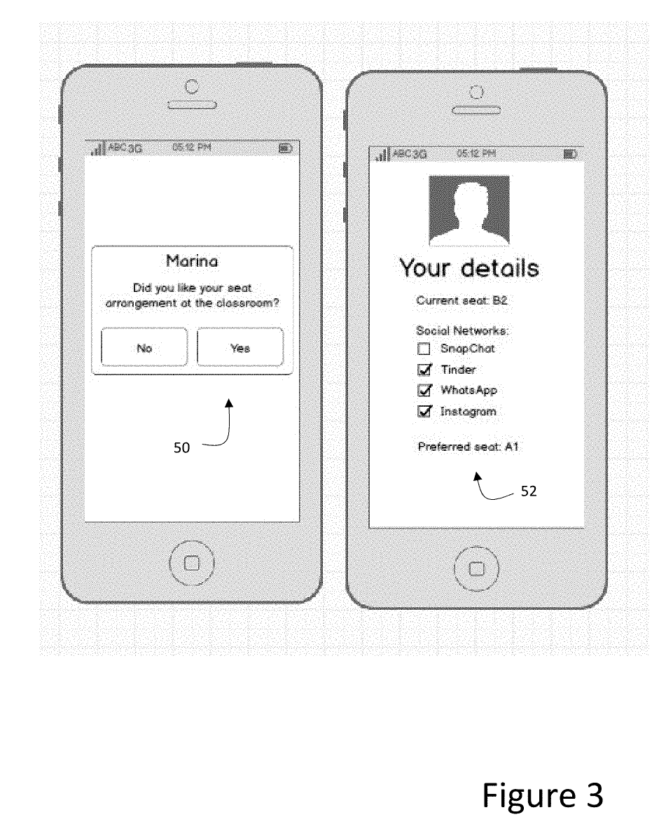

FIG. 3 depicts an illustrative user app for entering and displaying node related inputs 34, such, e.g., feedback 50 regarding a current seat location for the student, and profile details 52 such as social networks used by the student. In one approach, the student may enter feedback 50 about their seat after each class or periodically over time. The app may automatically recognize social network app on the student's phone, which can be used to capture profile information of the student.

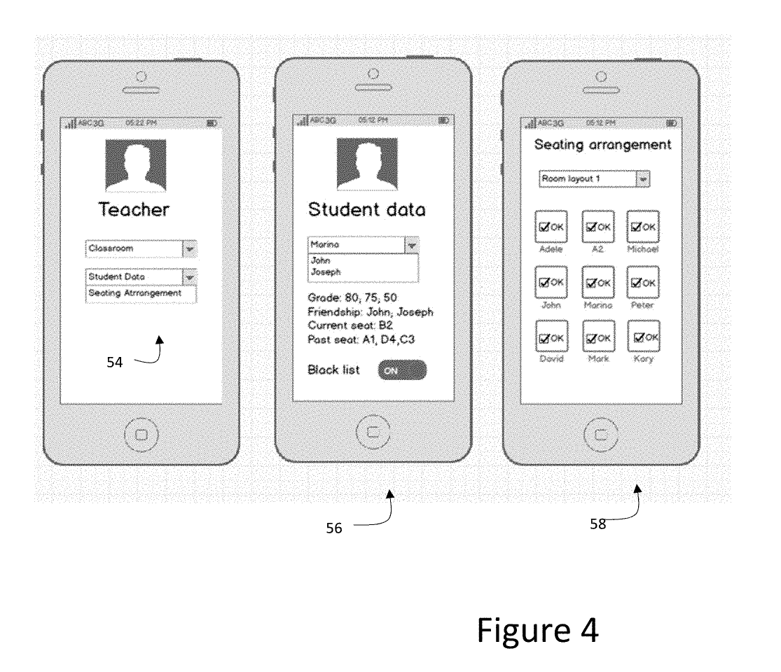

FIG. 4 depicts an illustrative teacher app interface that allows the teacher input and view classroom information 54, individual student data 56, and a generated seating arrangement 58. Friendships may be inferred based on social networks, as well as student seating preferences. It is understood the depicted interfaces in FIGS. 3 and 4 are for illustrative purposes only, and additional or different views and formats may be utilized to collect and display data.

The described system is thus capable of dynamically adjusting, adapting and proposing the best seating arrangement for tutors and/or teachers, as the system gains more and more knowledge with captured data.

It is understood that arrangement system 18 of FIG. 1 may be implemented as a computer program product stored on a computer readable storage medium.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the arrangement system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for arranging a set of nodes having disparate cognitive learning capabilities in a space, comprising:
an interface for receiving node related inputs that include structured data and unstructured data;
a retrieval system that identifies existing relationships and interactions among the nodes by analyzing external resource data;
a cognitive profile generator that generates a cognitive profile for each node in the set of nodes based on the node related inputs;
a compatibility determiner that determines a compatibility for each pair of nodes in the set of nodes based on generated cognitive profiles and existing relationships and interactions; and
an arrangement calculator that calculates an arrangement based on the compatibility determined for each pair of nodes.

2. The system of claim 1, wherein the set of nodes comprises a set of students, and the space comprises a classroom, and the external resource data comprises information obtained from social networks.

3. The system of claim 2, wherein the structured data comprises grades and the unstructured data comprises content written by the set of students.

4. The system of claim 3, wherein the cognitive profile generator includes a deep learning system that utilizes advanced natural language processing, information retrieval, knowledge representation, automated reasoning, and machine learning to determine the cognitive profile based on the structured data and unstructured data.

5. The system of claim 4, wherein the cognitive profile includes a learning type and a personality type.

6. The system of claim 2, wherein the compatibility determiner evaluates pairs of students based on a set of weighted parameters.

7. The system of claim 6, wherein at least one of the weighted parameters is determined from inputted sensor data.

8. A computer program product stored on a computer readable storage medium, which when executed by a computing system, arranges a set of nodes having disparate cognitive learning capabilities in a space, comprising:
program code for receiving node related inputs that include structured data and unstructured data;
program code that identifies existing relationships and interactions among the nodes by analyzing external resource data;
program code that generates a cognitive profile for each node in the set of nodes based on the node related inputs;
program code that determines a compatibility for each pair of nodes in the set of nodes based on generated cognitive profiles and existing relationships and interactions; and
program code that calculates an arrangement based on the compatibility determined for each pair of nodes.

9. The computer program product of claim 8, wherein the set of nodes comprises a set of students, and the space comprises a classroom.

10. The computer program product of claim 9, wherein the structured data comprises grades and the unstructured data comprises content written by the set of students, and wherein the external resource data comprises information from social networks.

11. The computer program product of claim 10, wherein the cognitive profile is generated with a deep learning system that utilizes advanced natural language processing, information retrieval, knowledge representation, automated reasoning, and machine learning.

12. The computer program product of claim 11, wherein the cognitive profile includes a learning type and a personality type.

13. The computer program product of claim 9, wherein the compatibility is determined for pairs of students based on a set of weighted parameters.

14. The computer program product of claim 13, wherein at least one of the weighted parameters is determined from inputted sensor data.

15. A computerized method for arranging a set of nodes having disparate cognitive learning capabilities in a space, comprising:
receiving node related inputs that include structured data and unstructured data;
identifying existing relationships and interactions among the nodes by analyzing external resource data;
generating a cognitive profile for each node in the set of nodes based on the node related inputs;
determining a compatibility for each pair of nodes in the set of nodes based on generated cognitive profiles and existing relationships and interactions; and
calculating an arrangement based on the compatibility determined for each pair of nodes.

16. The computerized method of claim 15, wherein the set of nodes comprises a set of students, and the space comprises a classroom.

17. The computerized method of claim 16, wherein the structured data comprises grades and the unstructured data comprises content written by the set of students, and wherein the external resource data comprises information from social networks.

18. The computerized method of claim 17, wherein the cognitive profile is generated with a deep learning system that utilizes advanced natural language processing, information retrieval, knowledge representation, automated reasoning, and machine learning.

19. The computerized method of claim 18, wherein the cognitive profile includes a learning type and a personality type.

20. The computerized method of claim 15, wherein the compatibility is determined for pairs of students based on a set of weighted parameters, and wherein at least one of the weighted parameters is determined from inputted sensor data.
